(19) United States
(12) Patent Application Publication
(10) Pub. No.: US 2015/0300589 A1
(43) Pub. Date: Oct. 22, 2015

(54) VEHICLE LAMP DEVICE

(71) Applicant: ICHIKOH INDUSTRIES, LTD., Isehara-shi, Kanagawa (JP)

(72) Inventor: Kazunori IWASAKI, Isehara-shi, Kanagawa-ken (JP)

(73) Assignee: ICHIKOH INDUSTRIES, LTD., Isehara-shi, Kanagawa-ken (JP)

(21) Appl. No.: 14/442,000

(22) PCT Filed: Oct. 17, 2013
(86) PCT No.: PCT/JP2013/078119

§ 371 Date: May 11, 2015

(30) Foreign Application Priority Data
Nov. 13, 2012 (JP) 2012-249478

(51) Int. Cl. F21S 8/10

(52) U.S. Cl. CPC F21S 48/1225; F21S 48/115; F21Y 2101/02

(57) ABSTRACT

[Problem] In conventional vehicle lamp devices, exit light exits from stepped partition surfaces without having been subjected to light distribution control.

[Solution] The present invention is provided with a lens, and a semiconductor-type light source. The lens is configured from one incidence surface, and nine exit surfaces partitioned by stepped partition surfaces. Among the nine exit surfaces, lower exit surfaces are positioned further towards a side in the exiting direction of light than upper exit surfaces. As a result, in the present invention, exit light exiting from horizontal stepped partition surfaces is subjected to light distribution control by the horizontal stepped partition surfaces which are downwardly inclined from above, is retracted downwards to the optical axis of the lens, and exits.

### TECHNICAL FIELD

The present invention relates to a direct lens type vehicle lamp device, which enters light from a semiconductor-type light source, and emits the incident light from the lens as a predetermined light distribution pattern.

### BACKGROUND ART

A vehicle lamp device of this type is conventional (e.g., Patent Literatures 1 and 2). Hereinafter a conventional vehicle lamp device will be descried.

The vehicle lamp device of Patent Literature 1 is provided with a lens and a light source. The lens is configured of a plurality of incident surfaces of an annular prism of a total reflection type Fresnel lens, and an exit surface that is radially divided into a plurality of portions. When the light source is turned on, light from the light source enters into the lens from the incident surface of the lens, and the incident light exits from the exit surface of the lens, and radiates to the front of a vehicle as a low beam light distribution pattern.

The vehicle lamp device of Patent Literature 2 is provided with a projection lens end a light source. The projection lens is configured of a plurality of lens portions that is radially divided around an optical axis. An exit surface of the plurality of divided lens portions has a different curvature. An incident surface of the plurality of divided lens portions is set to have the same thickness and focus. When the light source is turned on, light from the light source enters the plurality of divided lens portions from the incident surface of the plurality of divided lens portions, and the incident light exits from the exit surface of the plurality of divided lens portions, and radiates to the front of a vehicle as a predetermined light distribution pattern.

### CITATION LIST

### Patent Literature

Patent Literature 1: JP-A-2010-123447

Patent Literature 2: JP-A-2012-155902

### SUMMARY OF THE INVENTION

### Problems to be Solved by the Invention

The vehicle lamp device of Patent Literature 1is not provided with a means for light distribution control of exit light from a division step surface of the exit surface that is radially divided into a plurality of portions. The vehicle lamp device of Patent Literature 2 is also not provided with a means for light distribution control of exit light from a division step surface of the plurality of divided lens portions. Thus, in the conventional vehicle lamp devices, exit light not subjected to light distribution control may be emitted from a division step surface.

A problem to be solved by the present invention is that a conventional vehicle lamp device may emit exit light not subjected to light distribution control.

### Means for Solving the Problem

A vehicle lamp device according to first aspect of the present invention, comprising a lens and a semiconductor-type light source, wherein the lens comprises an incident surface, and an exit surface that is divided into a plurality of portions by a division step surface, and a lower exit surface of the plurality of exit surfaces is located toward a light exiting direction side than an upper exit surface.

The vehicle lamp device according to second aspect of the present invention, wherein an intermediate exit surface of the plurality of exit surfaces is located opposite to a light exiting direction than an exit surface of left and right end sides.

The vehicle lamp device according to third aspect of the present invention, wherein the division step surface of the plurality of exit surfaces is provided in a place other than a place where the semiconductor type light source is located, in a front view of the lens.

The vehicle lamp device according to fourth aspect of the present invention, wherein the plurality of exit surfaces is, at least, divided into an intermediate portion, a portion inside a vehicle, and a portion outside a vehicle, the exit surface of the intermediate portion emits a condensed light distribution pattern forming a cutoff line of a low beam light distribution pattern, the exit surface of the potion inside a vehicle emits a medium diffused light distribution pattern of the low beam light distribution pattern, and the exit surface of the portion outside a vehicle emits a large diffused light distribution pattern of the low beam light distribution pattern.

The vehicle lamp device according to fifth aspect of the present invention, wherein the exit surface of the intermediate portion, the exit surface of the portion inside a vehicle, and the exit surface of the portion outside a vehicle are each divided into an upper side portion, an intermediate portion, and a lower side portion.

### Effects of the Invention

In the vehicle lamp device of the present invention, a lower exit surface of the plurality of exit surfaces is located further toward a light exiting direction side than an upper exit surface, and a horizontal division step surface is inclined downward from the upper exit surface to the lower exit surface. As a result, the exit light exiting from the horizontal division step surface is subjected to light distribution control by the horizontal division step surface inclined downward, and exits in being infracted downward with respect to the optical axis of the lens.

Further, in the vehicle lamp device of the present invention, an intermediate exit surface of the plurality of exit surfaces is located further toward a light exiting direction side than an exit surface of left and right end sides, and a vertical division step surface is inclined from the left side to the right side across the intermediate exit surface to the right side exit surface, and inclined from the right side to the left side across the intermediate exit surface to the right side exit surface. As a result, the exit light exiting from the vertical division step surface is subjected to light distribution control by the vertical division step surface that is inclined from the left side to the right side or vice versa, and exits in being refracted to the outside with respect to the optical axis of the lens.

### BRIEF DESCRIPTION OF THE DRAWINGS

FIG. 1 is a plan view of an embodiment of a vehicle lamp device according to the present invention equipped with left and right vehicle lamp devices.

FIG. 2 is a front view showing a left side lamp unit.

FIG. 3 is a plan view showing a left side lamp unit (view taken along the arrow III in FIG. 2).

FIG. 4 is a side view showing a left side lamp unit (view taken along the arrow IV in FIG. 2).

FIG. 5 is a perspective view showing a left side lamp unit.

FIG. 6 is an explanatory perspective view showing a semiconductor-type light source.

FIG. 7 shows explanatory horizontal sectional views of an optical path from a left side lamp unit (explanatory sectional view taken along the line VIIA-VIIA in FIG. 2, explanatory horizontal sectional view taken along the line VIIB-VIIB line in FIG. 2, and explanatory sectional view taken along the line VIIC-VIIC in FIG. 2).

FIG. 8 shows explanatory vertical sectional views of an optical path from a left side lamp unit (explanatory sectional view taken along the line VIIIA-VIIIA in FIG. 2, explanatory sectional view taken along the line VIIIB-VIIIB in FIG. 2, and explanatory sectional view taken along the line VIIIC-VIIIC in FIG. 2).

FIG. 9 is an explanatory drawing showing a medium diffused light distribution pattern of a low beam light distribution pattern emitted from an exit surface of a lens of a left side lamp unit inside (right side of) a vehicle.

FIG. 10 is an explanatory drawing showing a condensed light distribution pattern forming a cutoff line of a low beam light distribution pattern emitted from an intermediate exit surface of a left side lamp unit.

FIG. 11 is an explanatory drawing showing a large diffused light distribution pattern of a low beam light distribution pattern emitted from an exit surface of a left side lamp unit outside (left side of) a vehicle.

FIG. 12 is an explanatory drawing showing an overhead sign light distribution pattern emitted from an auxiliary lens unit of a left side lamp unit.

FIG. 13 is an explanatory drawing showing a low beam light distribution pattern emitted from a lens of a left side lamp unit, and an overhead sign light distribution pattern emitted from an auxiliary lens unit of a left side lamp unit.

FIG. 14 is a partial vertical sectional view showing an optical path from a horizontal division step surface of a lens of a left side lamp unit (explanatory sectional view taken along the line XIV-XIV in FIG. 2).

FIG. 15 is a partial horizontal sectional view showing an optical path from a vertical division step surface of a lens of a left side lamp unit (explanatory sectional view taken along the line XIV-XIV in FIG. 2).

FIG. 16 is an explanatory drawing showing a light distribution pattern emitted from a horizontal division step surface and a vertical division step surface of a lens of a left side lamp unit, that is, a light distribution pattern by computer simulation.

### MODES FOR CARRYING OUT THE INVENTION

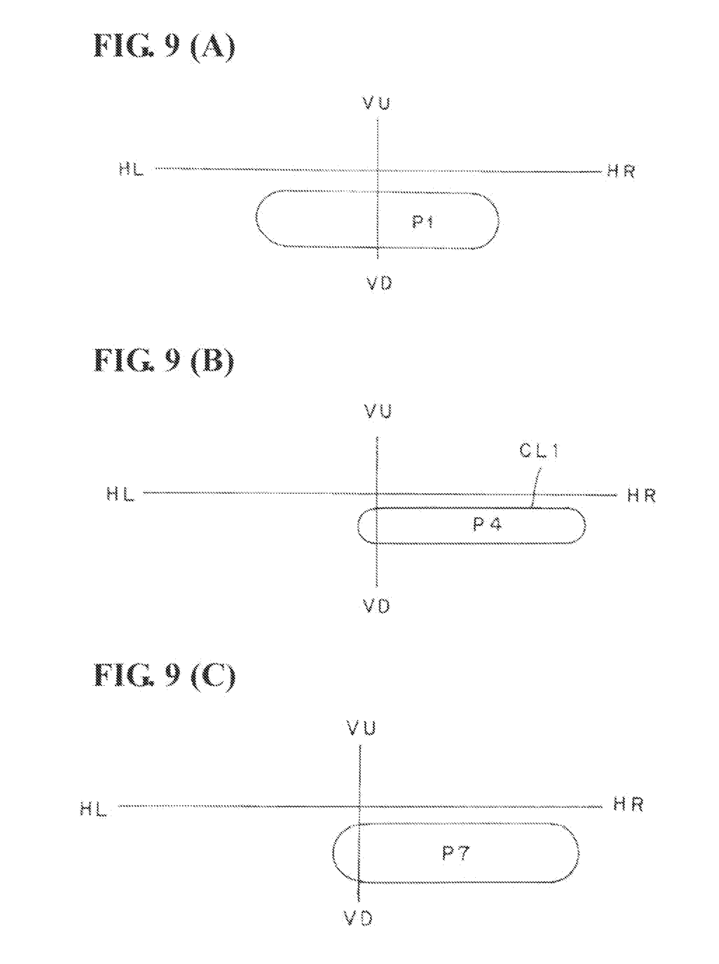

Hereinafter, embodiments (examples) of the vehicle lamp device of the present invention will be described with reference to the drawings. The invention is not limited to the embodiments. In FIGS. 9 to 13 and FIG. 16, A symbol “VU-VD” denotes an upper and lower vertical line of the screen. A symbol “HL-HR” denotes a left and right horizontal line of the screen. In this specification, front, back, top, bottom, left, right are front, back, top, bottom, left, right when a vehicle lamp device according to the present invention is mounted on a vehicle. Among the drawings, in a sectional view of a lens, hatching is omitted to clarify an optical path.

(Description of Configuration of Embodiment)

Hereinafter, a configuration of the vehicle lamp device according to the embodiment will be described. In the drawings, symbols 1L and 1R denote vehicle lamp devices according to the embodiment (e.g., a vehicle headlamp, a low beam headlamp). The vehicle lamp devices 1L and 1R are mounted on the left and right ends of the front of a vehicle C. Hereinafter, the left side vehicle lamp device 1L mounted on the left side of the vehicle C will be described. The left side vehicle lamp device 1L mounted on the left side of the vehicle C has substantially the same configuration (configuration that the left and right is substantially reverse), and a description thereof will be emitted.

(Description of Lamp Unit)

The vehicle lamp device 1L comprises a lamp housing (not shown), a lamp lens (not shown), a lens 2, a semiconductor-type light source 3, a heat sink member 4, and a not-shown holder (mounting member).

The lens 2, the semiconductor-type light source 3, the heat sink member 4, and the holder configure a lamp unit. The lamp housing and the lamp lens define a lamp chamber (not shown). The lamp units 2, 3, 4 are disposed in the lamp chamber and attached to the lamp housing via a vertical direction optical axis adjustment mechanism (not shown) and a horizontal direction optical axis adjustment mechanism (not shown). The lamp chamber may include lamp units other than the lamp units 2, 3, 4, for example, a fog light, a high beam headlamp, a low/high headlamp, a turn signal lamp, a clearance lamp, a daytime-running lamp, and a cornering lamp.

(Description of Semiconductor-Type Light Source 3)

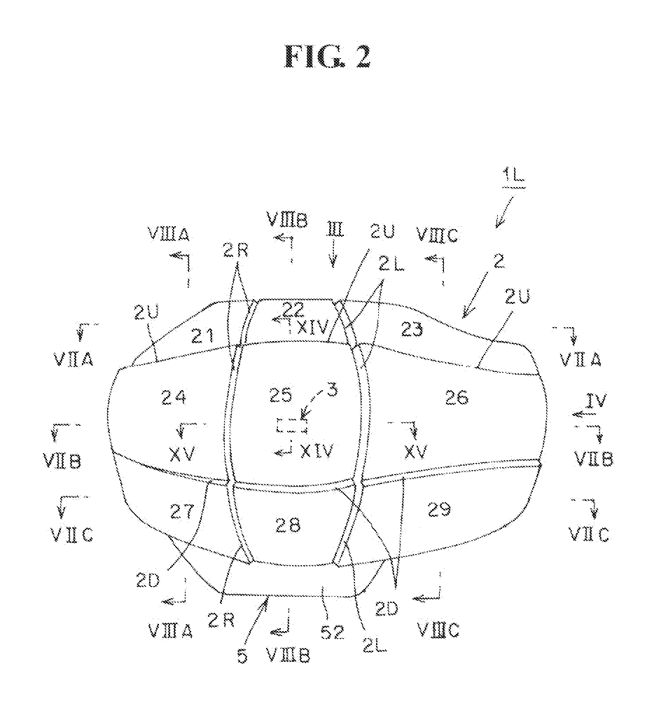

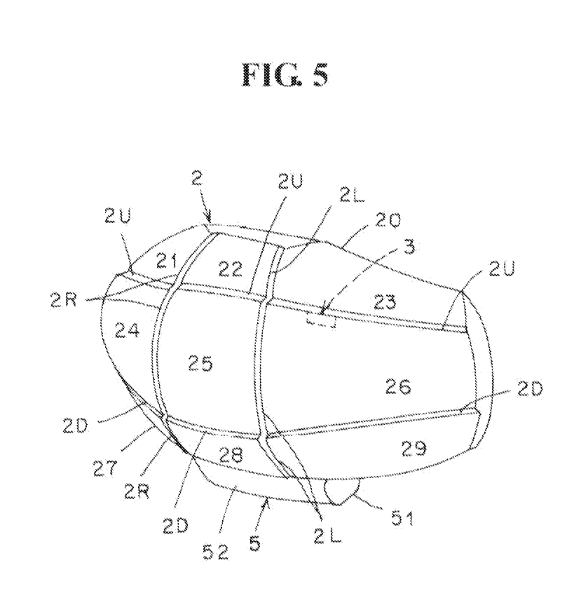

The semiconductor-type light source 3 is, as shown in FIGS. 2 to 8 and FIGS. 14 and 15, a self-emitting semiconductor-type light source, for example, an LED, OEL, or OLED (organic EL) in this example. The semiconductor-type light source 3 comprises a package (LED) package) that a light emitting chip (LED chip) 30 is sealed with a sealing resin member. The package is mounted on a substrate (not shown). Current is supplied to the light emitting chip 30 from a power source (battery) via a connector (not shown) attached to the substrate. The semiconductor-type light source 3 is attached to the heat sink member 4.

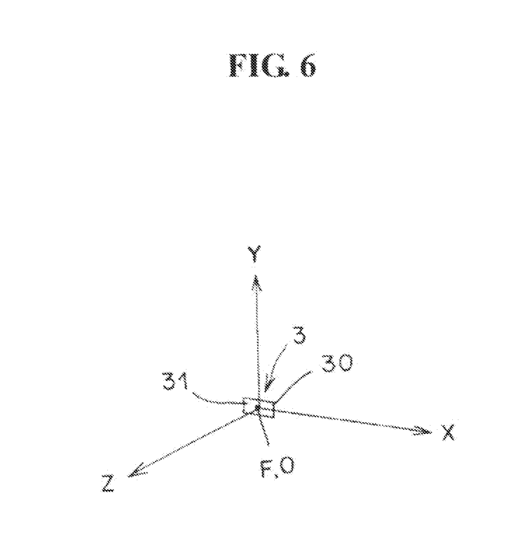

The light emitting chip 30 forms, as shown in FIG. 6, a flat square shape (flat rectangle). In other words, four square chips are arranged in the X-axis direction (horizontal direction). It is permitted to use two or three or more than five square chips, or to use a rectangular chip or a square chip. In this example, the front surface of the light emitting chip 30, the front surface of the rectangular chip in this example, forms a light emitting surface 31. The light emitting surface 31 faces the front of the reference optical axis (reference axis) Z of the lens 2. The center O of the light emitting chip 30 is located at or near a reference focal point F of the lens 2, and is located on or near a reference optical axis Z of the lens 2.

In FIG. 6, X, Y, Z constitutes an orthogonal coordinate (X-Y-Z orthogonal coordinate system). The X-axis is a horizontal axis in the lateral direction passing through the center O of the light emitting surface 31 of the light emitting chip 30, and is located outside a vehicle C, that is, the left side is a +direction and the right side is a (direction in the embodiment. The Y-axis is a vertical axis passing through the center O of the light emitting surface 31 of the light emitting chip 30, that is, the upper side is a +direction and the lower side is a −direction in the embodiment. Further, the Z-axis is a normal line (perpendicular line) passing through the center O of the light emitting surface 31 of the light emitting chip 30, that is, an axis (the reference optical axis Z of the lens 2) in the longitudinal direction orthogonal to the X-axis and Y-axis, that is, the front side is a +direction and the rear side is a −direction in the embodiment.

(Description of Lens 2)

The lens 2 is, as shown in FIGS. 2 to 5, FIG. 8, FIGS. 14 and 15, comprised of an incident surface 20, and a plurality of exit surfaces, nine in this example, that is, a first exit surface 21, a second exit surface 22, a third exit surface 23, a fourth exit surface 24, a fifth exit surface 25, a sixth exit surface 20, a seventh exit surface 27, an eighth exit surface 28, an a ninth exit surface 29 (hereinafter sometimes referred to as “exit surface 21-29”). The lens 2 is attached to the heat sink member 4 via the holder so as to face the semiconductor-type light source 3.

The lens 2 forms an asymmetrical shape in the front view (the exit surface 21-29). Thus, the lens 2 uses a lens dedicated to the left side vehicle lamp device 1L, and a lens dedicated to the right side vehicle lamp device 1R.

(Description of Incident Surface 20)

The incident surface 20 is a surface facing the semiconductor-type light source 3, and is continuously formed by a quadratic surface or a complex quadratic surface or a free curved surface in this example.

(Description of Exit Surface 21-29)

The exit surface 21-29 is a surface opposite to a surface facing the semiconductor-type light source 3, and is horizontally divided into three portions, and vertically divided into three portions, a total of nine portions, by two vertical division step surfaces 2L and 2R and two horizontal division step surfaces 2U and 2D.

In other words, the exit surface 21-29 is divided into three portions that is, an intermediate portion 22, 25, 28, a vehicle C inside (right side) portion 21, 24, 27, and a vehicle C outside (left side) portion 23, 26, 29, by two vertical division step surfaces 2L and 2R. The exit surface 21-29 is divided into three portions, that is, an upper side portion 21, 22, 23, a central portion 24, 25, 26, and a lower side portion 27, 28, 29, by two horizontal division step surfaces 2U and 2D. As a result, the exit surface 21-29 is horizontally divided into three portions, and vertically divided into three portions, a total of nine portions, by two vertical division step surfaces 2L and 2R and two horizontal division step surfaces 2U and 2D.

Among nine exit surfaces 21 to 29, the lower exit surfaces 24, 25, 26 or 27, 28, 29 are, as shown in FIGS. 2, 4, 5, 8, 14, located further toward the exiting direction side of the light L1 to L9 and L50 (the solid arrow direction side in the drawings) than the front exit surfaces 21, 22, 23 or 24, 25, 26. In other words, they are convex to the front side with respect to the reference optical axis Z of the lens 2 (front of the direction of the reference optical axis Z of the lens 2, the direction away from the semiconductor-type light source 3).

Among nine exit surfaces 21 to 29, the intermediate exit surfaces 22, 25, 28 are, as shown in FIGS. 2 to 5, FIG. 7, FIG. 15, located further opposite to the exiting direction of the light L1 to L9 and L50 than the exit surfaces 21, 24, 27, and 23, 26, 29 of the left and right end sides (on the opposite side of the solid arrow direction in the drawings). In other words, they are concave to the rear side with respect to the reference optical axis Z of the lens 2 (rear of the direction of the reference optical axis Z of the lens 2, the direction approaching the semiconductor-type light source 3).

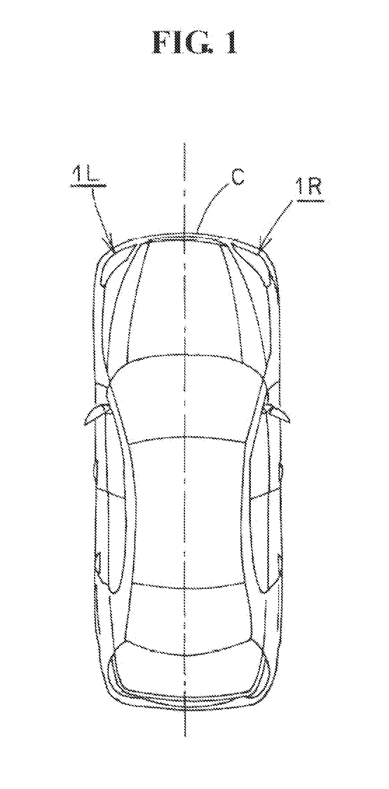

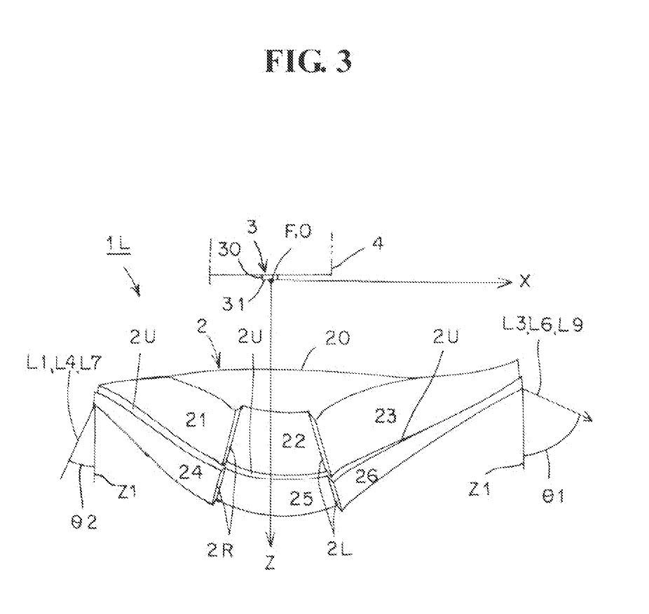

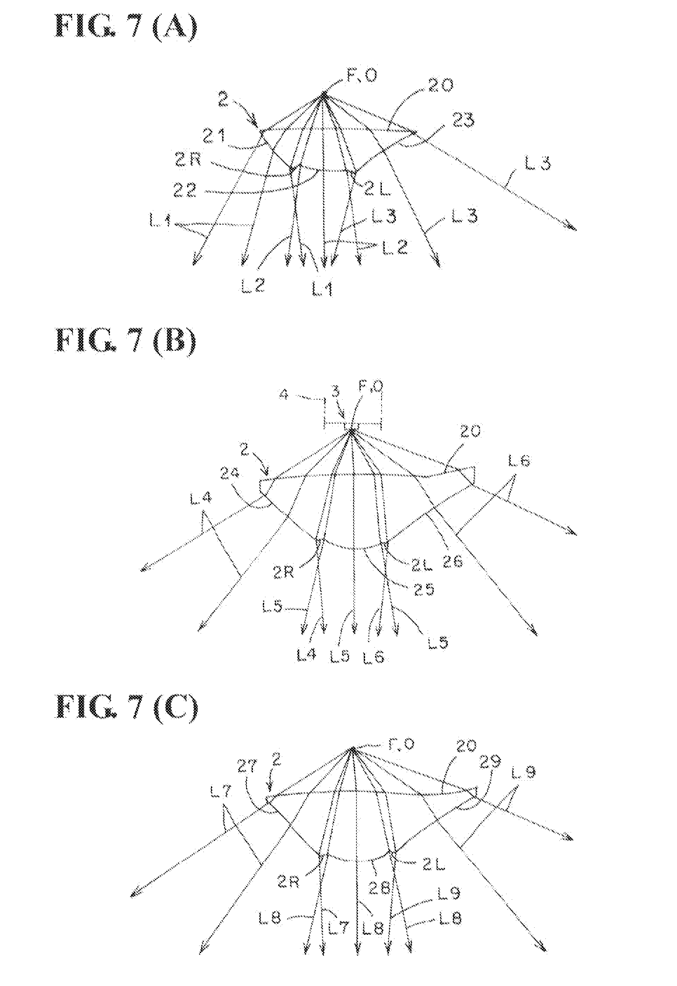

Nine exit surfaces 21 to 29 are formed independently of each of a free curved, a complex quadratic surface, and a quadric surface in this example. Nine exit surfaces 21 to 29 are, as shown in FIGS. 3 and 7, in the plan view of the lens 2, curved and inclined (slanted) from the front side to the rear side of the vehicle C, along the curved slope (slant) of left and right ends of the front of the vehicle C in FIG. 1, across the inside of the vehicle C (right side in this example) to the outside (left side in this example).

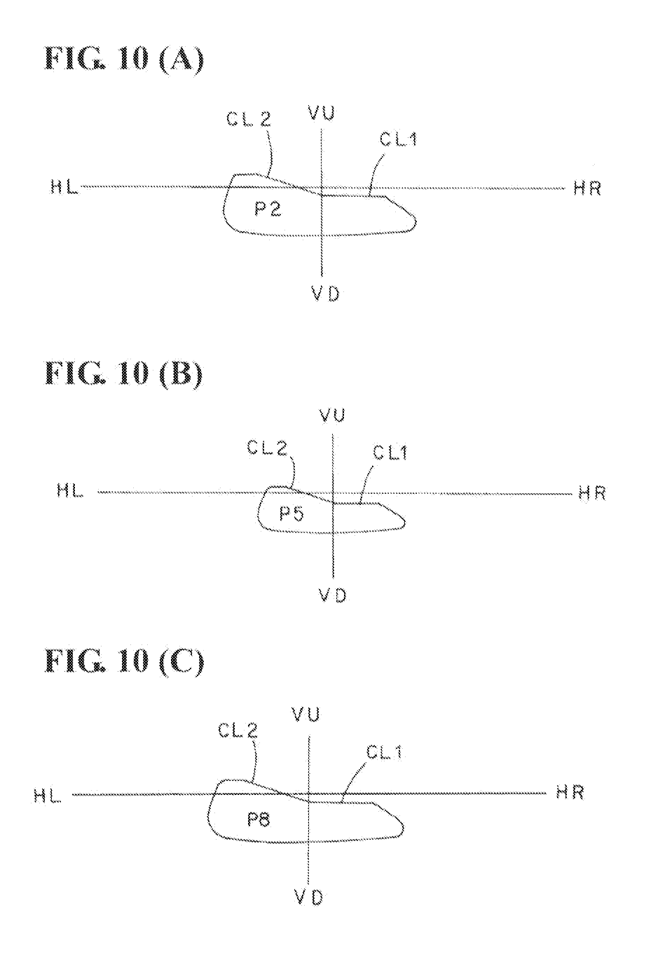

The intermediate three exit surfaces, that is, the second exit surface 22, the fifth exit surface 25, eighth exit surface 28, as shown in FIGS. 10 (A), (B), (C), emit condensed light distribution patterns P2, P5, P8 forming a horizontal cutoff line CL1 and an oblique cutoff line CL2 of a low beam light distribution pattern LP.

Three exit surfaces inside (right side of) the vehicle C, that is, the first exit surface 21, the fourth exit surface 24, seventh exit surface 27, as shown in FIGS. 9 (A), (B), (C), emit medium diffused light distribution patterns P1, P4, P7 of the low beam light distribution pattern LP.

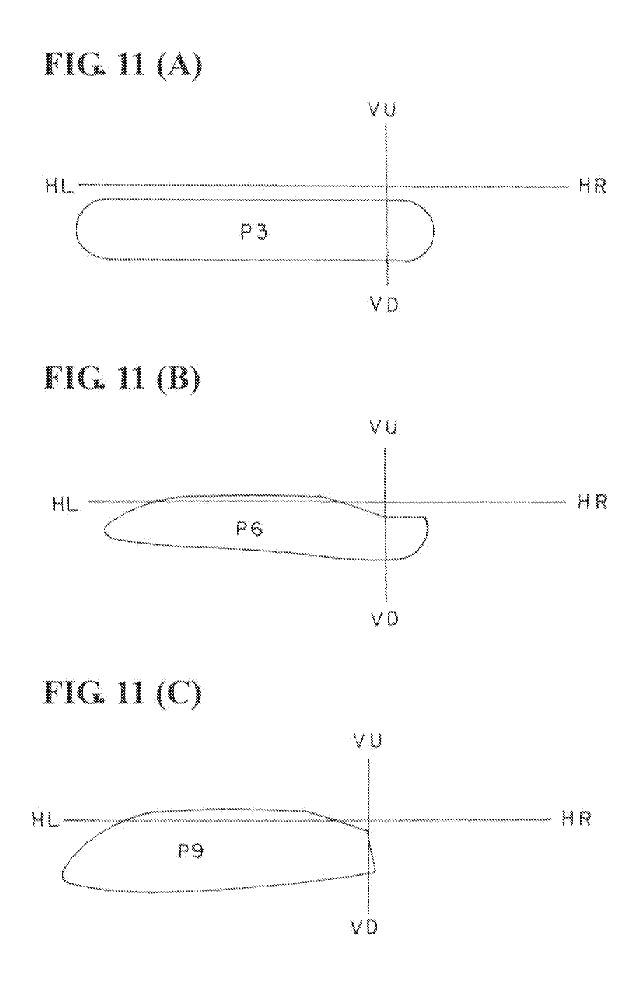

Three exit surfaces outside (left side of) the vehicle C, that is, the third exit surface 23, the sixth exit surface 26, ninth exit surface 29, as shown, in FIGS. 11 (A), (B), (C), emit large diffused light distribution patterns P3, P6, P9 of the low beam light distribution pattern LP.

(Description of Light Distribution Patterns P1 to P9)

In each of the light distribution patterns P1 to P5, light from the semiconductor-type light source 3 is subjected to light distribution control by the incident surface 20 and nine exit surfaces 21 to 29 of the lens 2. The details thereof will be described below.

The condensed light distribution pattern P5 emitted from the central fifth exit surface 25 has been most condensed, as shown in FIG. 10 (B), and has been substantially uniformly distributed to the left and right with respect to the upper and lower vertical line VU-VD of the screen. The horizontal cutoff line CL1 of the opposite lane side (right side) is located on the lower side with respect to the left and right horizontal line HL-HR of the left and right of the screen, and the oblique cutoff line CL2 of the cruising lane side (left side) diagonally intersects the left and right horizontal line HL-HR of the screen.

The condensed light distribution pattern P2 emitted from the upper side second exit surface 22, and the condensed light distribution pattern P8 emitted from the lower side eighth exit surface 28 are, as shown in FIG. 10 (A), (C), slightly diffused vertically and horizontally from the central condensed light distribution pattern P5.

The medium diffused light distribution pattern P4 emitted from the central fourth exit surface 24 is, as shown in FIG. 9 (B), mostly distributed to the right side with respect to the upper and lower vertical line VU-VD of the screen. The horizontal cutoff line CL1 is located on the lower side with respect to the left and right horizontal line HL-HR of the screen.

The medium diffused light distribution pattern P1 emitted from the upper side first exit surface 21 has been slightly diffused vertically and horizontally from the central medium diffused light distribution pattern P4, as shown in FIG. 9 (A), and has been substantially uniformly distributed to the left and right with respect to the upper and lower vertical line VU-VD of the screen, and has been distributed to the lower side with respect to the left and right horizontal line HL-HR of the screen.

The medium diffused light distribution pattern P7 emitted from the lower side seventh exit surface 27 has been slightly diffused vertically and horizontally from the central medium diffused light distribution pattern P4, as shown in FIG. 9 (C), and substantially in the same manner as the medium diffused light distribution pattern P4, has been mostly distributed to the right side with respect to the upper and lower vertical line VU-VD of the screen, and has been distributed to the lower side with respect to the left and right horizontal line HL-HR of the screen.

The large diffused light distribution pattern P6 emitted from the central sixth exit surface 26 has been mostly distributed to the left side with respect to the upper and lower vertical line VU-VD of the screen, as shown in FIG. 11 (B), and has been mostly distributed to the lower side with respect to the left and right horizontal line HL-HR of the screen.

The large diffused light distribution pattern P3 emitted from the upper side third exit surface 23 has been mostly distributed to the left side with respect to the upper and lower vertical line VU-VD of the screen, as shown in FIG. 11 (A), and has been distributed to the lower side with respect to the left and right horizontal line HL-HR of the screen.

The large diffused light distribution pattern P9 emitted from the lower side ninth exit surface 29 has been slightly diffused vertically from the central large diffused light distribution pattern P6, as shown in FIG. 11 (C), and substantially in the same manner as the large diffused light distribution pattern P6, has been mostly distributed to the left side with respect to the upper and lower vertical line VU-VD of the screen, and has been mostly distributed to the lower side with respect to the left and right horizontal line HL-HR of the screen.

(Description of Division Step Surfaces 2L, 2R, 2U, 2D)

The division step surfaces 2L, 2R, 2U, 2D of nine exit surfaces 21 to 29 are, as shown in FIG. 2, provided in places other than the place where the semiconductor-type light source 3 is located (place indicated by a dashed line in FIG. 2) in the front view of the lens 2. The division step surfaces 2L, 2R, 2U, 2D are inclined.

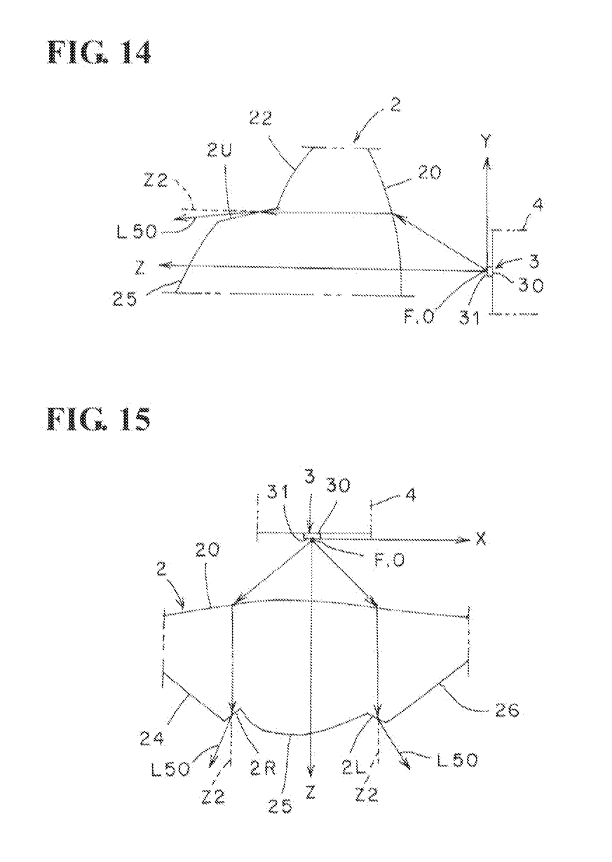

In other words, two horizontal division step surfaces 2U and 2D are, as shown in FIGS. 2, 4, 5, 8, 14 inclined from the front side to the rear side of the vehicle C, across the upper exit surfaces 21, 22, 23 or 24, 25, 26 to the lower exit surfaces 24, 25, 26 or 27, 28, 29. As a result, the exit light L50 exiting from two horizontal division step surfaces 2U and 2D are, as shown in FIG. 14, subjected to light distribution control by two horizontal division step surfaces 2U and 2D inclined downward from the rear side to the front side of the vehicle C, and exits in being refracted downward with respect to the optical axis Z2 (axis parallel to the reference optical axis Z). FIG. 14 shows the exit light L50 exiting from the horizontal division step surface 2U. The exit light L50 exiting from the lower horizontal division step surface 2D exits also in being refracted downward.

Two vertical division step surfaces 2L and 2R are, as shown in FIGS. 2 to 5, FIG. 7, FIG. 15, inclined from the rear side to the front side of the vehicle C, across the intermediate exit surfaces 22, 25, 28 to the right end exit surfaces 21, 24, 27 and the left end exit surfaces 23, 26, 29. As a result, the exit light L50 exiting from two vertical division step surfaces 2L and 2R are, as shown in FIG. 15, subjected to light distribution control by two vertical division step surfaces 2L and 2R, which are inclined from the rear side to the front side of the vehicle C, across the middle portion to the left and right sides, and exits in being refracted to the outside with respect to the optical axis Z2 (axis parallel to the reference optical axis Z). In other words, the exit light L50 exiting from the right side vertical division step surface 2R exits in being refracted to the right side, and the exit light L50 exiting from the left side vertical division step surface 2L exits in being refracted to the left side.

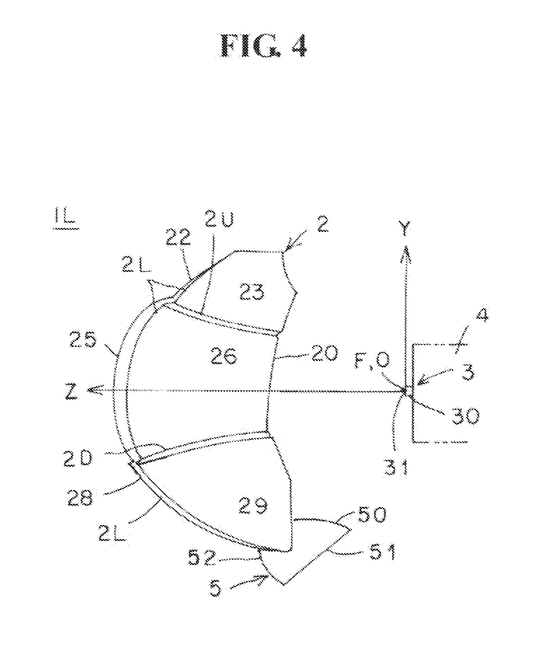

The inclination of the division step surfaces 2L, 2R, 2U, 2D substantially coincides with a draft of a mold (not shown) of the lens 2. In other words, the division step surfaces 2L, 2R, 2U, 2D are, as shown in FIGS. 3 and 4, slightly inclined with respect to the longitudinal direction of the vehicle C. In FIGS. 7, 8, 14, 15, in order to clarify the optical path, the division step surfaces 2L, 2R, 2U, 2D are shown in being largely inclined with respect to the longitudinal direction of the vehicle C.

(Description of Heat Sink Member 4)

The heat sink member 4 radiates heat generated by the semiconductor-type light source 3 to the outside. The heat sink member 4 is, for example, made of aluminum die casting or resin member having heat conductivity and electrical conductivity. The heat sink member 4 comprises a vertical plate portion, and a plurality of vertical plate shape fin portions provided integrally on a surface of the vertical plate portion (a surface of the rear side, a rear surface).

The semiconductor-type light source 3 is mounted on the other surface (a surface of the front side, a front surface) of the vertical plate portion of the heat sink member 4. The lens 2 is attached to the heat sink member 4 so as to face the semiconductor-type light source 3 through the holder.

(Description of Auxiliary Lens Unit 5)

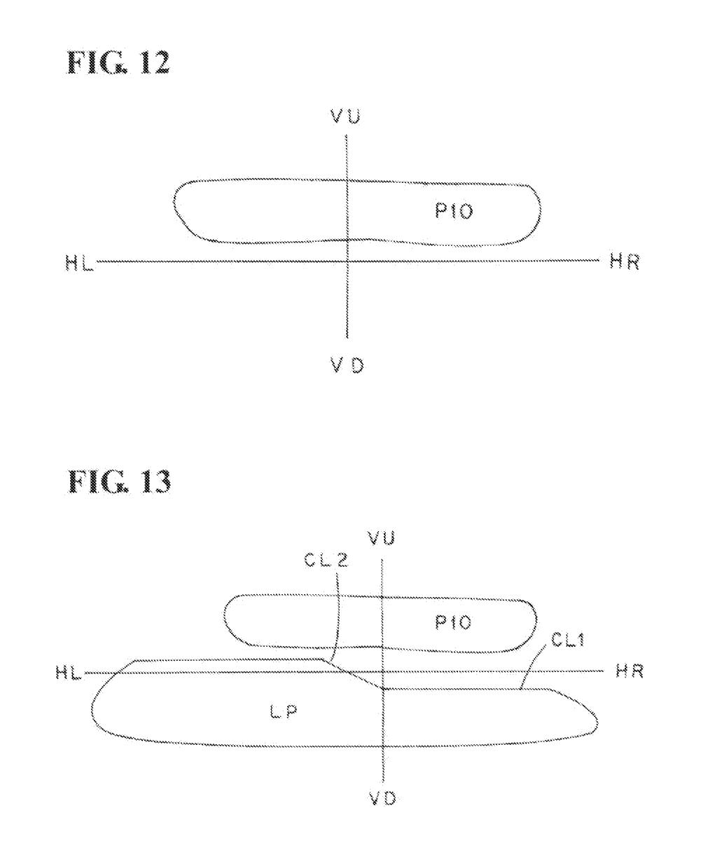

An auxiliary lens unit 5 is integrally provided on the lower side of the lens 2. The auxiliary lens unit 5 comprises an incident surface 50, a total reflection surface 51, and an exit surface 52. The auxiliary lens unit 5 enters light from the semiconductor-type light source 3 from the incident surface 50, totally reflects the incident light by the total reflection surface 51, emits the totally reflected light from the exit surface 52, and as shown in FIGS. 12 and 13, radiates the exit light L10 as an overhead sign light distribution pattern P10.

The overhead sign light distribution pattern P10 formed by the auxiliary lens unit 5 is an auxiliary light distribution pattern for a main light distribution pattern of the low beam light distribution pattern LP formed by the lens 2.

(Description of Functions of the Embodiment)

The vehicle lamp devices 1L and 1R according to the embodiment have the configuration described above. Hereinafter the functions of the embodiment will be described.

When the semiconductor-type light source 3 is tuned on, most of the light from the semiconductor-type light source 3 enters the lens 2 from the incident surface 20 of the lens 2. The incident light exits to the outside from nine exit surfaces 21 to 29. The exit light L1 to L9 radiates to the front of the vehicle C as nine light distribution patterns P1 to P9.

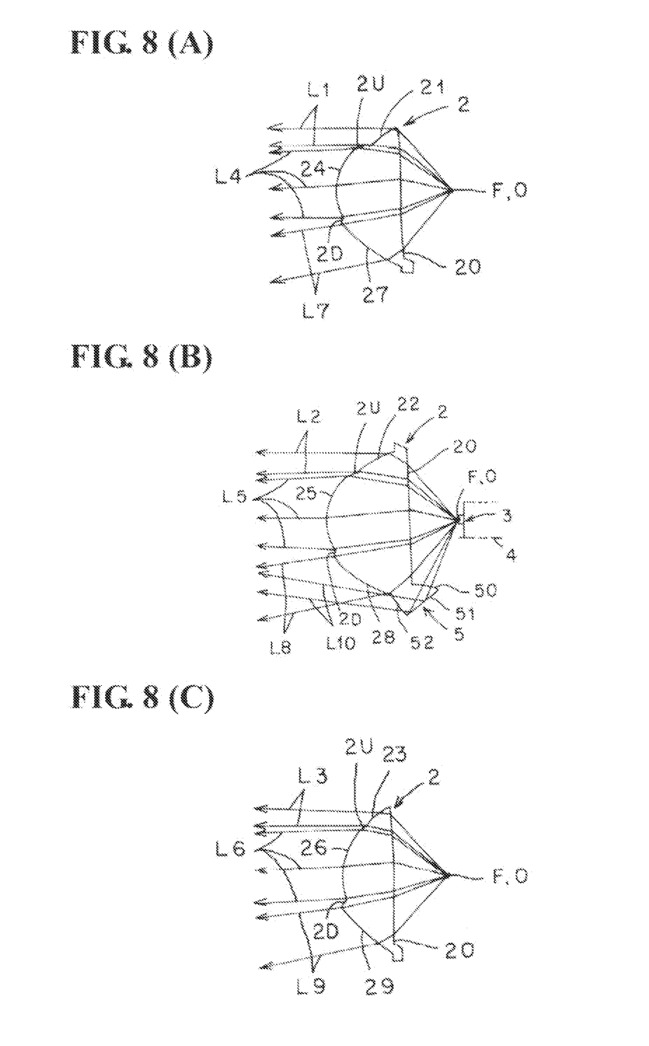

In other words, from the upper side first exit surface 21 on the right side, the exit light L1 (see FIG. 7 (A), FIG. 8 (A)) is emitted, and radiated to the front of the vehicle C as a medium diffused light distribution pattern P1 shown in FIG. 9 (A). From the intermediate upper side second exit surface 22, the exit light L2 (see FIG. 7 (A), FIG. 8 (B)) is emitted, and radiated to the front of the vehicle C as a condensed light distribution pattern P2 having a horizontal cutoff line CL1 and an oblique cutoff line CL2 shown in FIG. 10 (A). From the upper side third exit surface 23 of the left side, the exit light L3 (see FIG. 7 (A), FIG. 8 (C)) is emitted, and radiated to the front of the vehicle C as a large diffused light distribution pattern P3 shown in FIG. 11 (A).

From the right side central fourth exit surface 24, the exit light L4 (see FIG. 7 (B), FIG. 8 (A)) is emitted, and radiated to the front of the vehicle C as a medium diffused light distribution pattern P4 having a horizontal cutoff line CL1 shown in FIG. 9 (B). from the intermediate central fifth exit surface 25, the exit light L5 (see FIG. 7 (B), FIG. 8 (B)) is emitted, and radiated to the front of the vehicle C as a most condensed light distribution pattern P5 having a horizontal cutoff line CL1 and an oblique cutoff line CL2 shown in FIG. 10 (B). Front the left side central sixth exit surface 26, the exit light L6 (see FIG. 7 (B), FIG. 8 (C)) is emitted, and radiated to the front of the vehicle C as a large diffused light distribution pattern P6 shown in FIG. 11 (B).

From the right side lower seventh exit surface 27, the exit light L7 (see FIG. 7 (C), FIG. 8 (A)) is emitted, and radiated to the front of the vehicle C as a medium diffused light distribution pattern P7 shown in FIG. 9 (C). From the intermediate lower eight exit surface 28, the exit light L8 (see (FIG. 7 (C), FIG. 8 (B)) is emitted, and radiated to the front of the vehicle C as a condensed light distribution pattern P8 having a horizontal cutoff line CL1 and an oblique cutoff line CL2 shown in FIG. 10 (C). From the left side lower ninth exit surface 29, the exit light L9 (see (FIG. 7 (C), FIG. 8 (C)) is emitted, and radiated to the front of the vehicle C as a large diffused light distribution pattern P9 shown in FIG. 11 (C).

Here, three intermediate exit surfaces, that is, the second exit surface 22, the fifth exit surface 25, and the eighth exit surface 28 emit, as shown in FIGS. 10 (A), (B), (C), condensed light distribution patterns P2, P5, P8 forming a horizontal cutoff line CL1 and an oblique cutoff line CL2 of a low beam light distribution pattern LP.

Three exit surfaces inside (right side of) the vehicle C, that is, the first exit surface 21, the fourth exit surface 24, and the seventh exit surface 27 emit, as shown in FIGS. 9 (A), (B), (C), medium diffused light distribution patterns P1, P4, P7 of a low beam light distribution pattern LP. The exit light L1, L4, L7 from the from the first exit surface 21, the fourth exit surface 24, and seventh exit surface 27 are, as shown in FIG. 3, distributed at a small angle θ2 (about 25°) to the outside (inside, right side of the vehicle C) with respect to the optical axis Z1 (axis parallel to the reference optical axis Z).

Three exit surfaces outside (left side of) the vehicle C, that is, the third exit surface 23, the sixth exit surface 26, and the ninth exit surface 29 emit, as shown in FIGS. 11 (A), (B), (C), large diffused light distribution patterns P3, P6, P9 of a low beam light distribution pattern LP. The exit light L3, L6, L9 from the third surface 23, the sixth exit surface 26, and the ninth exit surface 29 are, as shown in FIG. 3, distributed at a large angle θ1 (about 65°) to the outside (outside, left side of the vehicle C) with respect to the optical axis Z1 (axis parallel to the reference optical axis Z).

By superimposing nine light distribution patterns P1 to P9, the low beam light distribution pattern LP shown in FIG. 13 is formed. The low beam light distribution pattern LP shown in FIG. 13 is emitted from the left side vehicle lamp device 1L, and is slightly biased to the left side with respect to the upper and lower vertical line VU-VD of the screen. For example, it is about 60° to the left side, and about 40° to the right side of the upper and lower vertical line VU-VD of the screen.

The low beam light distribution pattern emitted from the right side vehicle lamp device 1R is, though not shown, as compared with the low beam light distribution pattern LP shown in FIG. 13, unchanged in the horizontal cutoff line CL1 and the oblique cutoff line CL2, and is slightly biased to the right side with respect to the upper and lower vertical line VU-VD of the screen. For example, it is about 40° to the left side and about 60° to the right side of the upper and lower vertical line VU-VD of the screen.

By superimposing the low beam light distribution pattern LP emitted from the left side vehicle light device 1L shown in FIG. 13 and the not-shown low beam light distribution pattern emitted from the right side vehicle lamp device 1R, an ideal low beam light distribution pattern (not shown) with the left and right ends biased about 60° to the left and right sides of the upper and lower vertical line VU-VD of the screen.

On the other hand, a part of light from the semiconductor-type light source 3 enters into the auxiliary lens unit 5 from the incident surface 50 of the auxiliary lens unit 5. The incident light is totally reflected by the total reflection surface 51 of the auxiliary lens unit 5. The totally reflected light exits to the outside from the exit surface 52 of the auxiliary lens unit 5. The exit light L10 is radiated to an upper area of the front of the vehicle C as an overhead sign light distribution pattern P10 shown in FIG. 13.

Here, the incident light entered into the lens 2 is subjected to light distribution control by the division step surfaces 2U, 2D, 2L, 2R of the lens 2, and emitted to the outside from the division step surfaces 2U, 2D, 2L, 2R of the lens 2. In other words, the exit light L50 exiting to the outside from two horizontal division step surfaces 2U and 2D is, as shown in FIG. 14, subjected to light distribution control by two horizontal division step surfaces 2U and 2D, and emitted in being refracted downward with respect to the optical axis (axis parallel to the reference optical axis Z). The exit light L50 exiting from two vertical division step surfaces 2L and 2R is, as shown in FIG. 15, subjected to light distribution control by two vertical division step surfaces 2L and 2R, and emitted in being refracted outward with respect to the optical axis (axis parallel to the reference optical axis Z).

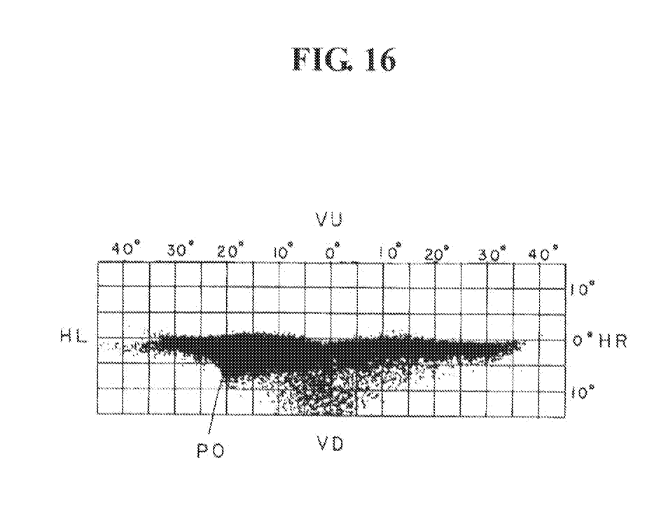

As a result, the light distribution P0 formed by the exit light L50 exiting to the outside from the division step surfaces 2U, 2D, 2L, 2R (hereinafter referred to as “light distribution from a step surface”) becomes a light distribution shown in FIG. 16. In other words, the upper edge is located lower than the left and right horizontal line HL-HR of the screen, the central portion is diffused downward, and the left and right end portions are diffused to the left and right. In particular, the central portion of the upper edge of the light distribution P0 from the step surface (central portion corresponding to the portion where the upper and lower vertical line VU-VD and the left and right horizontal line HL-HR of the screen intersect) is located lower than the left and right horizontal line HL-HR.

(Description of Effect of the Embodiment)

The vehicle lamp device 1L, 1R according to the embodiment has the aforementioned configuration and functions. Hereinafter, the effects of the embodiment will be described.

In the vehicle lamp device 1L, 1R according to the embodiment, among nine exit surfaces 21 to 29, the lower exit surfaces 24, 25, 26 or 27, 28, 29 are located further toward the exiting direction side of the light L1 to L9 and L50 than the front exit surfaces 21, 22, 23 or 24, 25, 26. In other words, they are convex to the front side with respect to the reference optical axis Z of the lens 2 (front of the direction of the reference optical axis Z of the lens 2, the direction away from the semiconductor-type light source 3). Thus, two horizontal division step surfaces 2U and 2D are vertically inclined, across the upper exit surfaces 21, 22, 23 or 24, 25, 26 to the lower exit surfaces 24, 25, 26 or 27, 28, 29. As a result, the exit light L50 exiting from two horizontal division step surfaces 2U and 2D is, as shown in FIG. 14, subjected to light distribution control by two horizontal division step surfaces 2U and 2D that are vertically inclined, and exits in being refracted downward with respect to the optical axis Z2 (axis parallel to the reference optical axis Z).

In the vehicle lamp device 1L, 1R according to the embodiment, among nine exit surfaces 21 to 29, the intermediate exit surfaces 22, 25, 28 are located further further opposite to the exiting direction of the light L1 to L9 and L50 than the exit surfaces 21, 24, 27, and 23, 26, 29 of the left and right end sides. In other words, they are concave to the rear side with respect to the reference optical axis Z of the lens 2 (rear of the direction of the reference optical axis Z of the lens 2, the direction approaching the semiconductor-type light source 3). Thus, two vertical division step surfaces 2L and 2R are inclined from the left side to the right side, across the intermediate exit surfaces 22, 25, 28 to the right side exit surfaces 21, 24, 27, and inclined from the right side to the left side, across the intermediate exit surfaces 22, 25, 28 to the left side exit surfaces 23, 26, 29. As a result, the exit light L50 exiting from two vertical division step surfaces 2L and 2R is, as shown in FIG. 15, subjected to light distribution control by two vertical division step surfaces 2L and 2R inclined from the left side to the right side or vice versa, and exits in being refracted outward with respect to the optical axis Z2 (axis parallel to the reference optical axis Z). In other words, the exit light L50 exiting from the right side vertical division step surface 2R exits in being refracted to the right side, and the exit light L50 exiting from the left side vertical division step surface 2L exits in being refracted to the left side.

As described above, in the vehicle lamp device 1L, 1R according to the embodiment, the exit light L50 exiting to the outside from two horizontal division step surfaces 2U and 2D, as shown in FIG. 14, exits in being refracted downward with respect to the optical axis Z2 (axis parallel to the reference optical axis Z), and the exit light L50 exiting from two vertical division step surfaces 2L and 2R, as shown in FIG. 15, exits in being outward with respect to the optical axis Z2 (axis parallel to the reference optical axis Z). As a result, the light distribution P0 from the step surface formed by the exit light L50 exiting to the outside from the division step surfaces 2U, 2D, 2L, 2R is distributed downward and outward, respectively, with respect to the horizontal cutoff line CL1 and the oblique cutoff line CL2 of the low beam distribution pattern LP. In other words, as shown in FIG. 16, the central portion of the upper edge of the light distribution P0 from the step surface is located below the left and right horizontal line HL-HR. Therefore, it is possible to suppress an increase of the light that is distributed upward with respect to the horizontal cutoff line CL1 and the oblique cutoff line CL2 of the low beam light distribution pattern LP, or it is possible to eliminate the light that is distributed upward.

In the vehicle lamp device 1L, 1R according to the embodiment, as the lens 2 is comprised of one incident surface 20, compared with the vehicle lamp device of Patent Literature 1, in which an incident surface of a lens comprises a plurality of annular prisms of a total reflection type Fresnel lens, it is possible to simplify the structure of the incident surface 20 of the lens 2, and it is possible to reduce the manufacturing cost by that portion.

In the vehicle lamp device 1L, 1R according to the embodiment, as the division step surfaces 2U, 2D, 2L, 2R of nine exit surfaces 21 to 29 are, in the front view of the lens 2, provided in places other than the place where the semiconductor-type light source 3 is located, compared with the vehicle lamp device of Patent Literature 2, in which the incident surface and the exit surface of a plurality of divided lens portions are radially divided around the optical axis, strongest light out of the light from the semiconductor-type light source 3 does not pass through the division step surfaces 2U, 2D, 2L, 2R, and it is possible to directly contribute to the light distribution without any optical loss such as refraction.

In the vehicle lamp device 1L, 1R according to the embodiment, three intermediate exit surfaces, that is, the second exit surface 22, the fifth exit surface 25, and the eighth exit surface 28 emit, as shown in FIGS. 10 (A), (B), (C), the condensed light distribution patterns P2, P5, P8 forming the horizontal cutoff line CL1 and the oblique cutoff line CL2 of the low beam light distribution pattern LP. In other words, three intermediate exit surfaces, that is, the second exit surface 22, the fifth exit surface 25, and the eighth exit surface 28 are located near the semiconductor-type light source 3, as compared with three exit surfaces inside (right side of) the vehicle C, that is, the first exit surface 21, the fourth exit surface 24, the seventh exit surface 27, and three exit surfaces outside (left side of) the vehicle C, that is, the third exit surface 23, the sixth exit surface 26, the ninth exit surface 29. Thus, the spectroscopic effects of the condensed light distribution patterns P2, P5, P8 formed by the second exit surface 22, the fifth exit surface 25, the eight exit surface 28 can be suppressed to lower than the the spectroscopic effects of the medium diffused light distribution patterns P1, P4, P7 formed by the first exit surface 21, the fourth exit surface 24, the seventh exit surface 27, and the spectroscopic effects of the large diffused light distribution patterns P3, P6, P9 formed by the third exit surface 23, the sixth exit surface 26, the ninth exit surface 29.

In the vehicle lamp device 1L, 1R according to the embodiment, three exit surfaces inside (right side of) the vehicle C, that is, the first exit surface 21, the fourth exit surface 24, the seventh exit surface 27 emit, as shown in FIGS. 9 (A), (B), (C) the medium diffused light distribution patterns P1, P4, P7 of the low beam light distribution pattern LP. Thus, as shown in FIG. 3, the exit light L1, L4, L7 from the first exit surface 21, the fourth exit surface 24, the seventh exit surface 27 can be distributed at a small angle θ2 (about 25°) to the outside (inside, right side of the vehicle C) with respect to the optical axis Z1 (axis parallel to the reference optical axis Z). Therefore, even when another vehicle structure is arranged further inside the vehicle C than the vehicle lamp device 1L, 1R, it is possible to emit the exit light L1, L4, and L7 from the first exit surface 21, the fourth exit surface 24, the seventh exit surface 27, avoiding the vehicle structure, and it is possible to eliminate a loss of light distribution.

In the vehicle lamp device 1L, 1R according to the embodiment, three exit surfaces outside (left side of) the vehicle C, that is, the third exit surface 23, the sixth exit surface 26, the ninth exit surface 29 emit, as shown in FIGS. 11 (A), (B), (C) the large diffused light distribution patterns P3, P6, P9 of the low beam light distribution pattern LP. Thus, as shown in FIG. 3, the exit light L3, L6, L9 from the third exit surface 23, the sixth exit surface 26, the ninth exit surface 29 can be distributed at a large angle θ1 (about 65°) to the outside (outside, left side of the vehicle C) with respect to the optical axis Z1 (axis parallel to the reference optical axis Z). Therefore, when the left and right ends of the front portion of the vehicle C are curved and inclined (slanted) from the front side to the rear side, across the inside to the outside, it is possible to distribute the exit light L3, L6, L9 from the third exit surface 23, the sixth exit surface 26, the ninth exit surface 29 to the outside at a large angle without being obstructed by the other vehicle structures.

As described above, in the vehicle lamp device 1L, 1R according to the embodiment, it is possible to obtain an ideal low beam light distribution pattern with the left and right ends spread to both left and right outsides (an ideal low beam light distribution pattern with left and right ends of about 60° to left and right sides from the upper and lower vertical line VU-VD of the screen), by the medium diffused light distribution patterns P1, P4, P7 formed by the exit light L1, L4, L7 from three exit surfaces inside (right side of) the vehicle C, that is, the first exit surface 21, the fourth exit surface 24, the seventh exit surface 27 inside (right side of) the vehicle C, and the large diffused light distribution patterns P3, P6, P9 formed by the exit light L3, L6, L9 from three exit surfaces, that is, the third exit surface 23, the sixth exit surface 26, the ninth exit surface 29 outside (left side of) the vehicle C.

In the vehicle lamp device 1L, 1R according to the embodiment, the exit surface 21-29 of the lens 2 is horizontally divided into three portions, and vertically divided into three portions, a total of nine portions, by two vertical division step surfaces 2L and 2R and two horizontal division step surfaces 2U and 2D. Therefore, in the light distribution patterns P1 to P9 formed by the exit light L1 to L9 emitted from nine exit surfaces 21 to 29, it is easy to perform light distribution, light distribution control, and light distribution design.

(Description of Examples Other Than the Embodiment)

In the embodiment, a vehicle headlamp and a low beam headlamp have been described. However, in the present invention, a vehicle lamp device other than the vehicle headlamp and low beam headlamp, for example, a fog lamp and a high beam headlamp may be used.

Further, in the embodiment, nine exit surfaces 21 to 29 of the lens 2 have been described. However, in the present invention, the number of exit surfaces of the lens 2 may be 2 to 8 or 10 or more. In such a case, when the number of exit surfaces increases, the light distribution control becomes easy, but contrary, a loss of light from the semiconductor-type light source 3 increases. Further, when the number of exit surfaces increases, it is possible to control to decrease a loss of the light from the semiconductor type light source 3, but contrary, it becomes difficult to control the light distribution. Thus, the number of exit surfaces is adjusted according to the balance between the light distribution control and the loss of the light from the semiconductor-type light source 3.

Still further, in the embodiment, the front view shape of the lens 2 (exit surfaces 21 to 29) is asymmetrical. However, in the present invention, the front view shape of the lens may be symmetrical, and the lens may be shared by the left side vehicle lamp device 1L and the right side vehicle lamp device 1R.

Furthermore, in the embodiment, the auxiliary lens unit 5 is provided on the lower side of the lens 2, thereby forming the overhead sign light distribution pattern P10. However, in the present invention, an auxiliary lens unit may be provided around the lens 2 for forming an auxiliary light distribution pattern other than the overhead sign light distribution pattern 10. A plurality of auxiliary lens units may be used for forming a plurality of auxiliary light distribution patterns. Further, an auxiliary lens unit may not be provided, and an auxiliary light distribution pattern may not be formed.

### DESCRIPTION OF REFERENCE NUMERALS

1L, 1R Vehicle lamp device

2 Lens

20 Incident surface

21, 22, 23, 24, 25, 26, 27, 28, 29 Exit surface

2L, 2R Vertical division step surface

2U, 2D Horizontal division step surface

3 Semiconductor-type light source

30 Light emitting chip

31 Light emitting surface

4 Heat sink member

5 Auxiliary lens unit 5

51 Incident surface

52 Total reflection surface

52 Exit surface

C Vehicle

CL1 Horizontal cutoff line

CL2 Oblique cutoff line

F Reference focus

HL-HR Left and right horizontal line of screen

O Center

P1, P4, P7 Medium diffused light distribution pattern

P2, P5, P8 Condensed light distribution pattern

P3, P6, P9 Large diffused light distribution pattern

P10 Overhead sign light distribution pattern

LP Low beam light distribution pattern

VU-VD Upper and lower vertical line of screen

X X axis

Y Y axis

Z Reference optical axis (Z axis)

1. A vehicle lamp device comprising a lens and a semiconductor-type light source, wherein
the lees comprises an incident surface, and an exit surface that is divided into a plurality of portions by a division step surface, and
a lower exit surface of the plurality of exit surfaces is located toward a light exiting direction side than an upper exit surface.

2. The vehicle lamp device according to claim 1, wherein an intermediate exit-surface of the plurality of exit surfaces is located opposite to a light exiting direction than an exit surface of left and right end sides.

3. The vehicle lamp device according to claim 1, wherein
the division step surface of the plurality of exit surfaces is provided in a place other than a place where the semiconductor-type light source is located, in a front view of the lens.

4. The vehicle lamp device according to claim 1, wherein
the plurality of exit surfaces is, at least, divided into an intermediate portion, a portion inside a vehicle, and a portion outside a vehicle,
the exit surface of the intermediate portion emits a condensed light distribution pattern forming a cutoff line of a low beam light distribution pattern,
the exit surface of the potion inside a vehicle emits a medium diffused light distribution pattern of the low beam light distribution pattern, and
the exit surface of the portion outside a vehicle emits a large diffused light distribution pattern of the low beam light distribution pattern.

5. The vehicle lamp device according to claim 4, wherein
the exit surface of the intermediate portion, the exit surface of the portion inside a vehicle, and the exit surface of the portion outside a vehicle are each divided into an upper side portion, an intermediate portion, and a lower side portion.
